(19) United States
(12) Patent Application Publication
(10) Pub. No.: US 2012/0032946 A1
(43) Pub. Date: Feb. 9, 2012

(54) NEW CALIBRATION PROCEDURES FOR THREE-DIMENSIONAL DIGITAL IMAGE CORRELATION

(76) Inventors: Wei-Chung WANG, Hsinchu City (TW); Bo-Fu CHEN, Hsinchu City (TW); Yi-Chieh HO, Hsinchu City (TW)

(21) Appl. No.: 12/850,107

(22) Filed: Aug. 4, 2010

(51) Int. Cl. G06T 15/00

(52) U.S. Cl. 345/419

(57) ABSTRACT

The present invention discloses new calibration procedures for three-dimensional digital image correlation (3D-DIC) method comprising steps: providing a 3D-DIC system: arranging an object at a focus of a first image capture device and a second image capture device, and using a light source device to uniformly project light on the object, and linking the system to a processor capable of data processing and analyzing; providing a calibration plate: arranging the calibration plate at a position where the object is located; performing a system calibration procedures: treating the first and second image capture devices as an identical unit and rotating them simultaneously to acquire a plurality of calibration images of the calibration plate, wherein each calibration image contains a plurality of circles formed at an identical spacing which is preset to work out a plurality of system parameters through the spacings for measurement and calculation of the object.

### FIELD OF THE INVENTION

The present invention relates to new calibration procedures for three-dimensional digital image correlation method, which is exempted from rotating the calibration plate, and thus applies to a micro-measurement, long-distance or wide-span object without using a rigid calibration plate.

### BACKGROUND OF THE INVENTION

With the advance of technology and science, the measurement technologies have been extensively applied to industrial fabrication and civil engineering. The measurement technologies can be categorized into the contact type and the non-contact type. The contact type measurement technologies have limited applications because they are destructive and time-consuming. The non-contact type measurement technologies, such as the optical measurement technologies, are widely used because of contactlessness, high measurement speed and high processing speed.

Among the optical measurement technologies, the 3-Dimensional Digital Image Correlation (3D-DIC) method is a non-contact and non-destructive three-dimensional digital image measurement and analysis method. Refer to FIG. 1 a diagram schematically showing a conventional 3D-DIC system. The conventional 3D-DIC system comprises a first image capture device 1, a second image capture device 2, a light source device 3, and a processor 4. The image capture devices 1 and 2 may be CCDs (Charge-Coupled Devices) or cameras. An object 5 is placed at a focus of the lenses of the image capture devices 1 and 2. The light source device 3 uniformly projects light on the object 5. The first and second image capture devices 1 and 2 simultaneously acquire the images of the surface of the object 5. The images are sent to the processor 4 for data processing and analyzing.

In analysis, the 3D-DIC method divides the captured images into a plurality of subsets. In the left diagram of FIG. 2 is shown a subset 50 of the un-deformed object 5. In order to increase the contrast effect and analysis precision, speckle patterns are randomly formed on the surface of the object 5, such as the gray-level patterns in FIG. 2. In the right diagram of FIG. 2 is shown an image of the deformed object 5, which is captured by the image capture devices 1 and 2. With a deformation theory and the related algorithm, the 3D-DIC method compares the patterns of the un-deformed object 5 and deformed object 5 to work out a subset 51 corresponding to the subset 50 and the displacement and strain of the subset 51. After the abovementioned analysis and operation has been performed on all the subsets, global deformation of the object 5 is constructed.

The 3D-DIC method must be calibrated to confirm the precision of following processes before data processing and analyzing. Refer to FIG. 1 again. In a conventional calibration method, a calibration plate 6 is provided firstly. The calibration plate 6 has a plurality of circles 61. The circles 61 are spaced at an identical distance which is preset. Next, the calibration plate 6 is rotated by an arbitrary angle (as indicated by the arrows in FIG. 1) before being arranged on the image capture devices 1 and 2. Next, the images of the circles 61 of the calibration plate 6 are analyzed. Then, the calibration is undertaken based on the given spacing among the circles 61.

The calibration plate 6 is usually made of a thicker metal plate lest the calibration plate 6 is deformed while rotation and the precision of calibration will be affected. There is also another type of the calibration plate 6 whose circles 61 are fabricated by machining. However, the metal plate is expensive, and it is also difficult that the circles 61 are machined with high precision. Therefore, the conventional technology is hard to practice.

The 3D-DIC method applies to wide extent, including civil engineering. When the 3D-DIC method is applied to a large building, the image capture devices 1 and 2 have to be installed at a position somewhat far away from the object 5. In such a case, rotating the calibration plate 6 is hard to practice. When the 3D-DIC method is applied to micro-measurement object, such as a millimeter or micron object, the calibration plate 6 is also formed in a smaller size. Therefore, the calibration plate 6 is hard to be rotated.

### SUMMARY OF THE INVENTION

One objective of the present invention is to provide new calibration procedures for three-dimensional digital image correlation method, which is exempted from rotating the calibration plate, and thus can perform calibration for a micro-measurement, long-distance or large-area object without rotating a rigid calibration plate.

The present invention proposes new calibration procedures for three-dimensional digital image correlation method, which comprises steps of providing a 3D-DIC method; arranging an object at a focus of a first image capture device and a second image capture device through the 3D-DIC system connected with a processor which performs data processing and analyzing, and using a light source device to uniformly project light on the object; providing a calibration plate, and fastening the calibration plate at the position identical to the object; performing a system calibration procedure: treating the first image capture device and second image capture device as an identical unit and rotating them simultaneously to acquire a plurality of calibration images of the calibration plate, wherein each calibration image contains a plurality of circles formed at an identical spacing which is preset; through the spacing, a plurality of system parameters are worked out for calculation and measurement of the object. As the present invention needn't rotate the calibration plate, it can be applied to a micro-measurement, long-distance or large-area measurement.

In comparison with the conventional technology, the procedures of the present invention are exempted from rotating the calibration plate and thus applicable to long-distance measurement. The present invention does not limit the rigidity of the calibration plate. Therefore, the calibration plate can be made of a slice-like material, and can be easily fabricated at a lower cost in one embodiment.

Below, the embodiments are described in detail in cooperation with the drawings to demonstrate the technical contents of the present invention.

### BRIEF DESCRIPTION OF THE DRAWINGS

The embodiments of the present invention are described in accompany with the following drawings.

FIG. 1 is a diagram schematically showing a conventional 3D-DIC system;

FIG. 2 is a diagram schematically showing a subset of the un-deformed object and a corresponding subset of the deformed object;

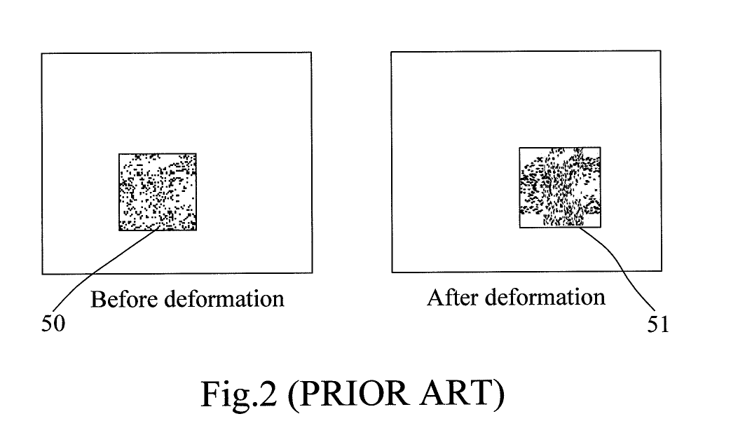

FIG. 3 is a diagram schematically showing a model of a 3D-DIC system according to the present invention;

FIG. 4 is a diagram schematically showing an embodiment of a 3D-DIC system according to the present invention;

FIG. 5 shows the topography of an object measured by a conventional calibration technology;

FIG. 6 shows the topography of an object measured by a calibration method according to the present invention; and

FIG. 7 is a comparison graph plotted according to the data in Table.1 and Table.2 of the present invention.

### DETAILED DESCRIPTION OF THE PREFERRED EMBODIMENTS

Below, the embodiments are described in detail to exemplify the present invention. However, the persons skilled in the art should understand that the embodiments are only to exemplify the present invention but not to limit the scope of the present invention and that any equivalent modification or variation according to the spirit of the present invention is to be also included within the scope of the present invention.

The technical contents of the present invention are described in detail in cooperation with the drawings below.

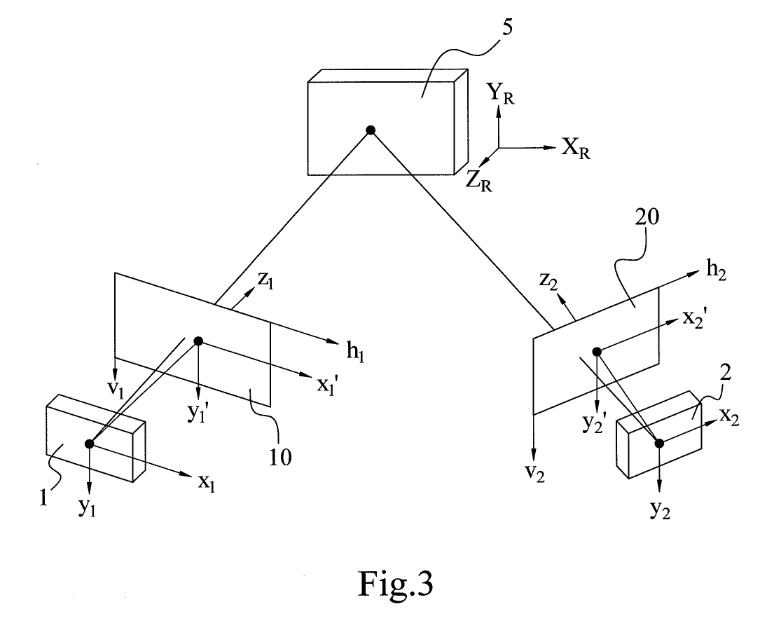

Refer to FIG. 3 a diagram schematically showing a model of a 3D-DIC system according to the present invention. The 3D-DIC system of the present invention comprises a first image capture device 1 and a second image capture device 2. The center of the lens of the first image capture device 1 is arranged at an origin of a first device coordinate axis (x1, y1, z1). The center of the lens of the second image capture device 2 is arranged at an origin of a second device coordinate axis (x2, y2, z2). The z1 axis of the first image capture device 1 coincides with the optical axis thereof. The z2 axis of the second image capture device 2 coincides with the optical axis thereof. The ideal image planes of the first and second image capture devices 1 and 2 appear at the fronts of the lenses thereof. The center of a first image plane 10 of the first image capture device 1 is defined to be an origin of a first image coordinate axis (x1′, y1′). The center of a second image plane 20 of the second image capture device 2 is defined to be an origin of a second image coordinate axis (x2′, y2′). A point of an object 5 can be designated as a reference coordinate axis (X_{R}, Y_{R}, Z_{R}). The device coordinate axes (x, y, z) of the first and second image capture devices 1 and 2 can be transformed into the reference coordinate axes (X_{R}, Y_{R}, Z_{R}) according to Equation (1):

$$[ \begin{matrix}{X}_{R} \\ {Y}_{R} \\ {Z}_{R}\end{matrix} ] = [ R ] [ \begin{matrix}x \\ y \\ z\end{matrix} ] + [ T ] \qquad ( 1 )$$

wherein [R] is a 3×3 rotation matrix containing three system parameters θₓ, θ_{y}, θ_{z}, and
wherein [T] is a translation matrix containing three system parameters Tₓ, T_{y}, T_{z}. Via the function relationships of similar triangles, the image coordinate axes (x′, y′) can be transformed via the device coordinate axes (x, y, z) according to Equation (2):

$${x}^{′} = f \frac{x}{z} ; {y}^{′} = f \frac{y}{z} \qquad ( 2 )$$

wherein f is the focal length of the lens.

If the seven system parameters θₓ, θ_{y}, θ_{z}, Tₓ, T_{y}, T_{z} and f are known, the 3D reference coordinate system can be transformed into the 2D image coordinate system according to Equations (1) and (2).

The abovementioned Equations (1) and (2) are ideal models. If the lens distortion is taken into consideration, the image coordinate system should be calibrated and transformed according to the distortion. The transformation relationship between the distortion coordinate axis (x_{d}′, y_{d}′) and the image coordinate axis (x′, y′) is expressed by Equation (3):

$$\{ \begin{matrix}{x}_{d}^{′} \\ {y}_{d}^{′}\end{matrix} \} = \{ \begin{matrix}\frac{2 {x}^{′}}{Ω} \\ \frac{2 {y}^{′}}{Ω}\end{matrix} \} \qquad ( 3 )$$

wherein Ω=1+\sqrt{1−4kᵢ(x′2+y′2)}, and wherein kᵢ is a radial distortion coefficient.

The captured image is stored in a digital image coordinate axis (h, v) of a processor 4, wherein the unit of the coordinate axis is pixel. As shown in FIG. 3, a first digital image coordinate axis (h1, v1) is corresponding to the first image capture device 1, and a second digital image coordinate axis (h2, v2) is corresponding to the second image capture device 2. The relationship between the digital image coordinate axis (h, v) and the distortion coordinate axis (x_{d}′, y_{d}′) is expressed by Equation (4):

h=x_{d}′+Cₓ

v=λy_{d}′+C_{y} (4)

wherein (Cₓ, C_{y}) is the coordinate of the center of the captured image in the digital image coordinate axis (h,v), and wherein λ is the aspect ratio of the image.

After the eleven system parameters θₓ, θ_{y}, θ_{z}, Tₓ, T_{y}, T_{z}, f, kᵢ, Cₓ, C_{y} and λ are acquired, all the points captured on the image coordinate axis (x′, y′) can be transformed into the digital image coordinate axis (h, v) according to Equations (1)-(4).

Before the 3D-DIC system performs measurement, the system parameters θₓ, θ_{y}, θ_{z}, Tₓ, T_{y}, T_{z}, f, kᵢ, C_{X}, C_{y} and λ should be acquired via the calibration procedures. Then, the measurement results of the object 5 can be obtained via comparison and calculation.

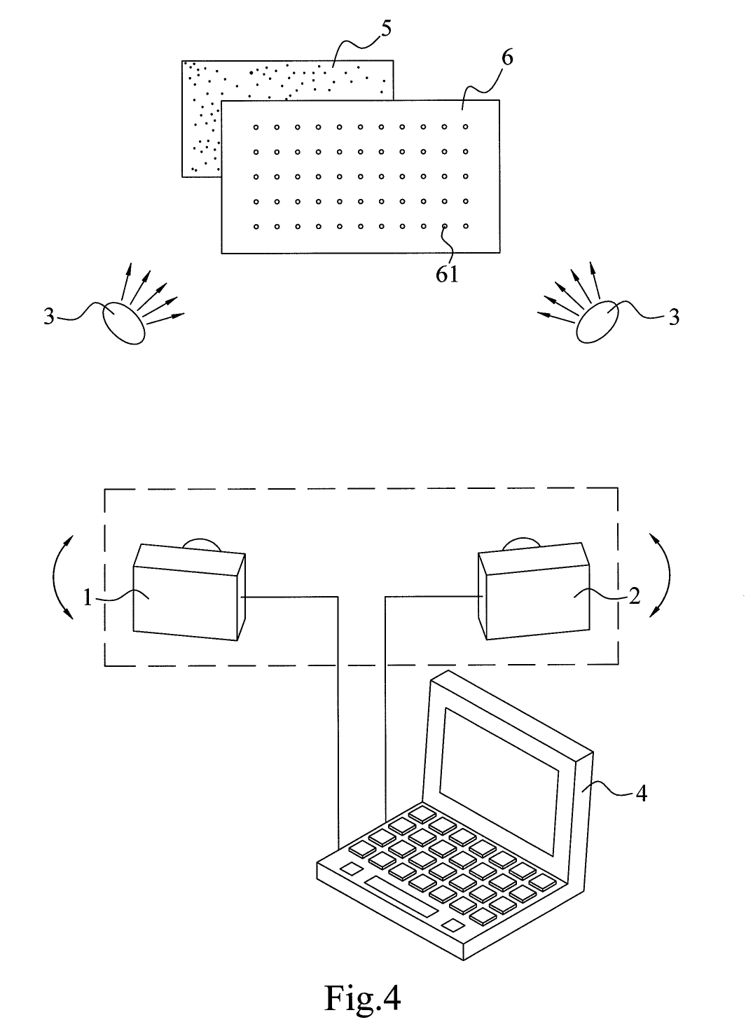

The present invention proposes new calibration procedures for 3D-DIC method. Refer to FIG. 4. In the calibration procedures of the present invention, a 3D-DIC system is provided firstly. The 3D-DIC system comprises a first image capture device 1, a second image capture device 2, a light source device 3, and a processor 4. An object 5 is placed at a focus of the lenses of the first image capture device 1 and the second image capture device 2. The light source device 3 projects light on the object 5 uniformly. The system inputs the images captured by the first and second image capture devices 1 and 2 into the processor 4. The processor 4 performs data processing and analyzing.

In one embodiment, a calibration plate 6 is provided. The calibration plate 6 is arranged at the position where the object 5 is located. In order to perform the calibration procedures and acquire the system parameters θₓ, θ_{y}, θ_{z}, Tₓ, T_{y}, T_{z}, f, kᵢ, Cₓ, C_{y} and λ, the first image capture device 1 and the second capture image device 2 are simultaneously rotated to obtain the calibration images. “Bing simultaneously rotated” means that the first and second image capture devices 1 and 2 are regarded as an identical unit to change the positions. The rotation includes the rotations and/or positions change around the three axes (indicated by the arrows in FIG. 4). Thus, different images are captured from different positions with the relative position of the first and second image capture devices 1 and 2 unchanged.

Among the eleven system parameters, θₓ, θ_{y}, θ_{z}, Tₓ, T_{y} and T_{z} are external parameters, and f, kᵢ, Cₓ, C_{y} and λ are internal parameters. The internal parameters are intrinsic to the image capture devices and will not be changed when the positions of the image capture devices are changed in calibration procedures. The external parameters are changed in calibration procedures. Suppose that the first and second image capture devices 1 and 2 are simultaneously rotated to obtain M pieces of calibration images in calibration procedures. Each calibration image is related to six unknown external parameters. Therefore, the M pieces of the calibration images have 6M (six times of M) pieces of external parameters. Suppose that each calibration image captures N pieces of circles 61 on the calibration plates 6. There are three coordinate parameters (X_{R}, Y_{R}, Z_{R}) related to the position of each circle 61. Thus, N pieces of circles 61 generate 3N (three times of N) pieces of unknown numbers. As the five internal parameters are not affected by rotation, they are not related to M or N. The M pieces of calibration images capture N pieces of circles 61 to generate 6M+3N+5 pieces of unknown numbers. In each calibration image, each circle 61 of the calibration plate 6 provides a value to solve the equations. Thus, M pieces of images provide MN (M times of N) pieces of values to solve the equations. When MN□ 6M+3N+5 for M pieces of calibration images, the captured calibration images are sufficient to solve all the system parameters in the calibration procedures. Solve M from MN□ 6M+3N+5 and obtain:

M>(3N+5)/(N−6) (5)

In other words, all the system parameters cannot be obtained unless the number M pieces of the calibration images satisfy Equation (5).

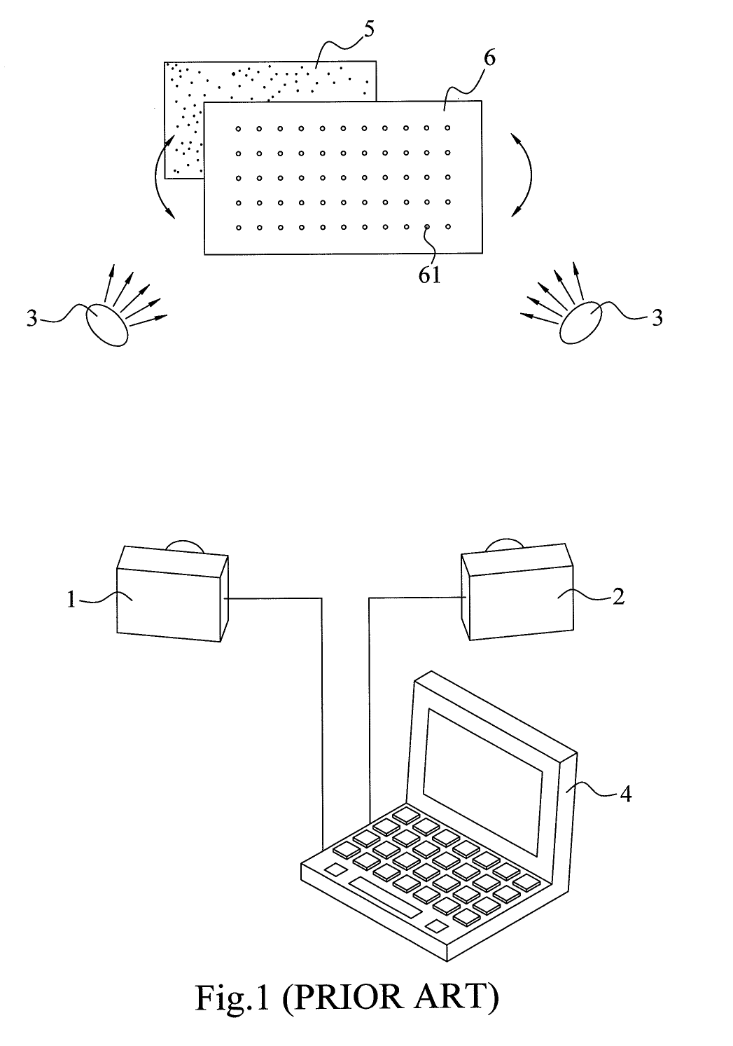

Refer to FIG. 1 again. In the conventional technology, the calibration plate 6 is rotated for calibration. Therefore, rigidity of the calibration plate 6 is required. Therefore, the calibration plate 6 of the conventional technology is usually made of a rigid material and precisely machined to form the circles 61. The calibration procedures of the present invention are exempted from rotating the calibration plate 6. In one embodiment of the present invention, the calibration plate 6 is made of a slice-like material, such as a piece of paper or a plastic plate, and the circles 61 are printed on the calibration plate 6. In practice, the calibration plate 6 made of the slice-like material is attached to the surface of the object 5 to perform calibration in an adhesive manner. Therefore, the calibration plate 6 is easy to fabricate at a lower cost without occupying too much space in the present invention.

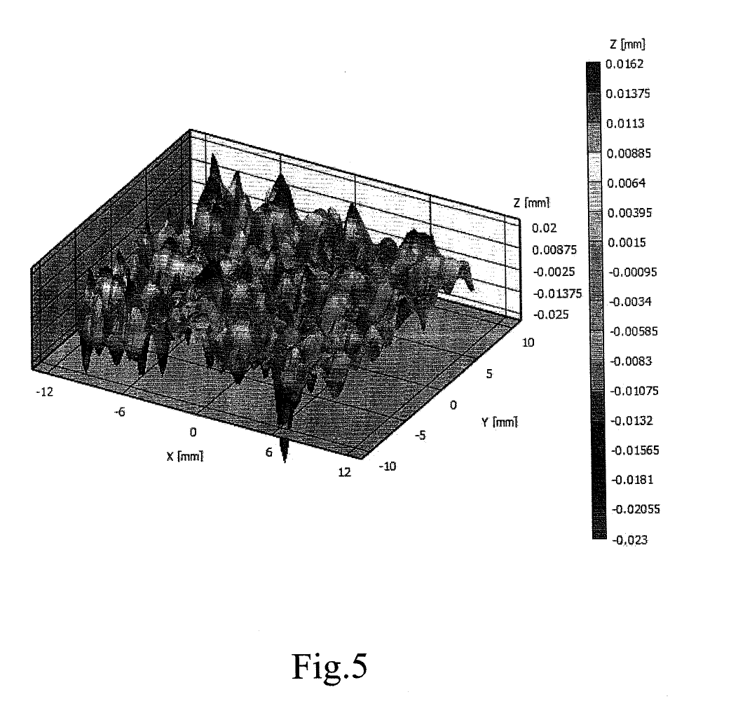

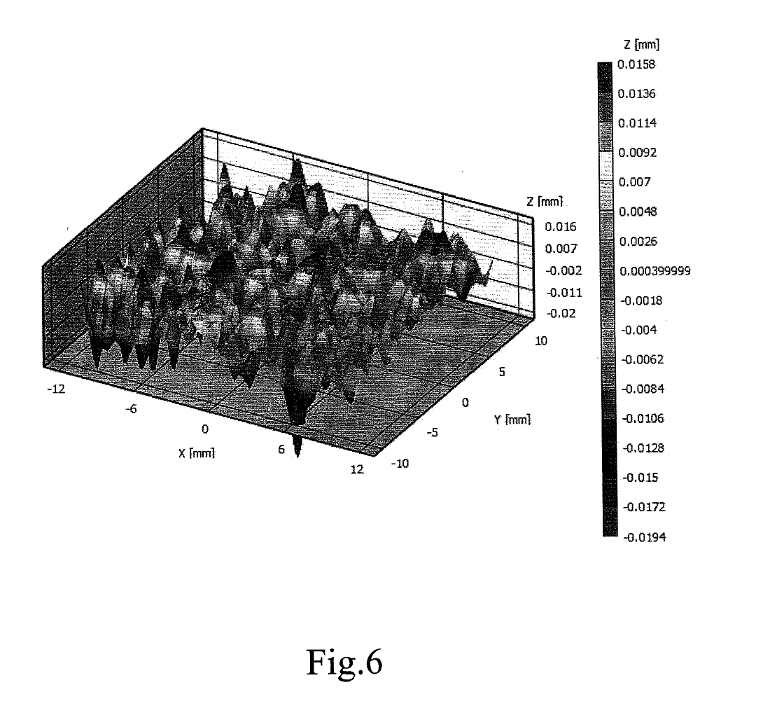

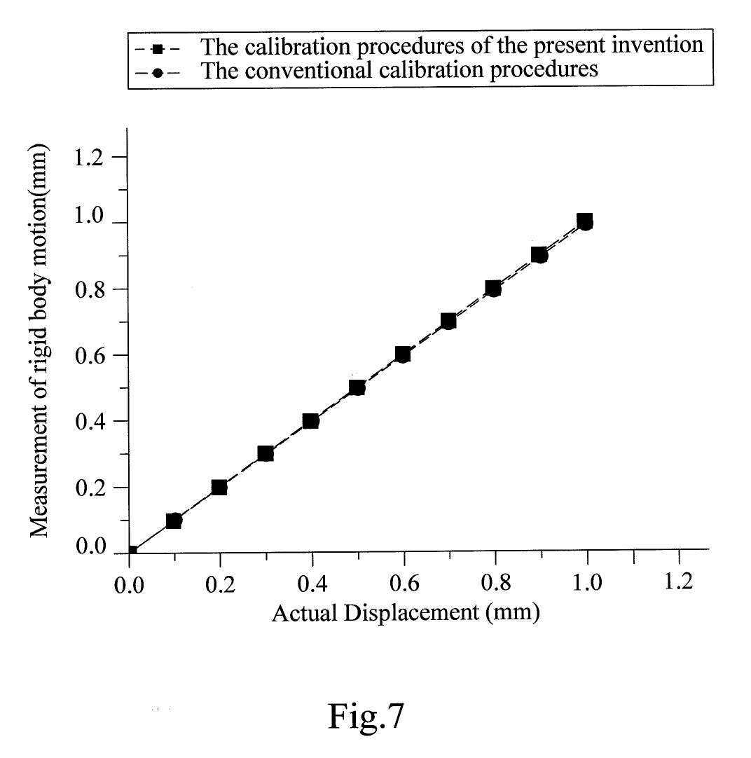

For verifying the accuracy of the calibration procedures of the present invention, the calibrations are respectively performed with the conventional technology and the procedures of the present invention to undertake measurement. FIG. 5 and FIG. 6 respectively show the topographies of a macroscopic object measured by the calibration procedures s of the conventional technology and the present invention, wherein the field of view shot by the image capture devices is about 50 mm*50 mm. The topography in FIG. 6 is almost identical to that in FIG. 5. In fact, failed calibration procedures will result in a seriously distorted topography. Therefore, the topographies prove the practicability of the calibration procedures of the present invention. Table.1 and Table.2 respectively show the data obtained by measuring a macroscopic rigid body motion with calibration procedures of the conventional technology and the present invention. The error percentage is a difference between the actual displacement and the measurement undertaken by different calibration procedures. FIG. 7 is a comparison graph plotted according to the data in Table.1 and Table.2. FIG. 7 proves that the experimental results of the two methods are almost identical. Table.3 shows the data obtained by measuring a microcosmic rigid body motion by the calibration procedures of the present invention. The measurement adopts image capture devices each having a high-resolution lens with the field of view of 3 mm*3 mm. The results show that the error of the 3D-DIC method calibrated by the procedures of the present invention is very small. Therefore, the procedures of the present invention can implement microcosmic measurement.

TABLE 1
The measurement of the rigid body motion implemented by
the conventional calibration procedures

| | Rigid body motion | |
|---|---|---|
| | measured by the | |
| Actual | conventional calibration | |
| displacement (mm) | procedures (mm) | Error (%) |
| 0.1 | 0.099382 | 0.62 |
| 0.2 | 0.198629 | 0.69 |
| 0.3 | 0.298717 | 0.43 |
| 0.4 | 0.397927 | 0.52 |
| 0.5 | 0.496397 | 0.72 |
| 0.6 | 0.59466 | 0.89 |
| 0.7 | 0.692633 | 1.05 |
| 0.8 | 0.791698 | 1.04 |
| 0.9 | 0.891195 | 0.98 |
| 1 | 0.988782 | 1.12 |

TABLE 2
The measurement of the rigid body motion implemented by
the calibration procedures of the present invention

| | Rigid body motion | |
|---|---|---|
| | measured by the | |
| | calibration procedures | |
| Actual | of the present invention | |
| displacement (mm) | (mm) | Error (%) |
| 0.1 | 0.0986577 | 1.34 |
| 0.2 | 0.198158 | 0.92 |
| 0.3 | 0.297187 | 0.94 |
| 0.4 | 0.398678 | 0.33 |
| 0.5 | 0.498635 | 0.27 |
| 0.6 | 0.596883 | 0.52 |
| 0.7 | 0.696831 | 0.45 |
| 0.8 | 0.796599 | 0.43 |
| 0.9 | 0.895341 | 0.52 |
| 1 | 0.994967 | 0.50 |

TABLE 3
The measurement of the microcosmic rigid body motion
implemented by the calibration procedures of the present invention

| | Rigid body motion | |
|---|---|---|
| | measured by the | |
| | calibration procedures | |
| Actual | of the present invention | |
| displacement (mm) | (mm) | Error (%) |
| 0.01 | 0.010296 | 2.96 |
| 0.02 | 0.020165 | 0.83 |
| 0.03 | 0.030205 | 0.68 |
| 0.04 | 0.040402 | 1 |
| 0.05 | 0.050442 | 0.88 |
| 0.06 | 0.060681 | 1.14 |
| 0.07 | 0.070779 | 1.11 |
| 0.08 | 0.080421 | 0.53 |
| 0.09 | 0.091522 | 1.69 |
| 0.10 | 0.101509 | 1.51 |
| | Average | 1.23 |

The embodiments described above are only to exemplify the present invention but not to limit the scope of the present invention. Any equivalent modification or variation according to the contents of the specification and the drawings of the present invention is to be also included within the scope of the present invention.

What is claimed is:

1. New calibration procedures for three-dimensional digital image correlation (3D-DIC) method, comprising steps of
(a) providing a 3D-DIC system, wherein an object is arranged at a focus of a first image capture device and a second image capture device, and a light source device projects light uniformly on the object, and the 3D-DIC system is connected with a processor capable of data processing and analyzing;
(b) providing a calibration plate, and fastening the calibration plate at a position where the object is located; and
(c) performing a system calibration procedure, wherein the first image capture device and the second image capture device are treated as an identical unit and rotated simultaneously to obtain a plurality of calibration images; each calibration image includes a plurality of circles formed at an identical spacing which is preset to work out a plurality of system parameters through the spacings for measurement and calculation of the object.

2. The new calibration procedures for 3D-DIC method according to claim 1, wherein the first image capture device and the second image capture device are simultaneously rotated without changing their relative positions to perform rotations and/or positions change along three axes.

3. The new calibration procedures for 3D-DIC method according to claim 1, wherein the calibration plate is made of a slice-like material and the circles are printed on the calibration plate, and the calibration plate is attached to a position where the object is located in an adhesive manner.

4. The new calibration procedures for 3D-DIC method according to claim 3, wherein the slice-like material is a piece of paper or a plastic plate.

5. The new calibration procedures for 3D-DIC method according to claim 1 further comprising a step (d) of performing a measurement process after step (c).

6. The new calibration procedures for 3D-DIC method according to claim 1, wherein there are eleven system parameters.

7. The new calibration procedures for 3D-DIC method according to claim 6, wherein when there are M pieces of the calibration images and when each calibration image includes N pieces of circles of the calibration plate, the system parameters are not be solved by the captured calibration image unless M is greater than (3N+5)/(N−6).
